(19) United States
(12) Patent Application Publication
(10) Pub. No.: US 2022/0368208 A1
(43) Pub. Date: Nov. 17, 2022

(54) ELECTRIC SCOOTER WITH ENHANCED CHARGING

(71) Applicant: BRAVO SPORTS, Santa Fe Springs, CA (US)

(72) Inventor: Jack B. Lovley, II, Lake Forest, CA (US)

(21) Appl. No.: 17/555,306

(22) Filed: Dec. 17, 2021

Related U.S. Application Data
(60) Provisional application No. 63/127,944, filed on Dec. 18, 2020.

(51) Int. Cl. H02K 35/02; A63C 17/26; B62J 6/12

(52) U.S. Cl. CPC H02K 35/02; A63C 17/26; B62J 6/12; A63C 2203/14

(57) ABSTRACT

According to some embodiments, a manually-powered movable device comprises at least one wheel configured to move when a user operates the device, an electrical energy generating assembly, wherein the electrical energy generating assembly comprises a magnet assembly and a coil assembly, wherein the magnet assembly is configured to move when the at least one wheel is moved, wherein the coil assembly is configured to remain stationary relative to a frame of the device when the at least one wheel is moved, and wherein relative movement between the magnet assembly and the coil assembly generates electrical energy, at least one wire assembly coupled to the electrical energy generating assembly, and at least one output device coupled to the at least one wire assembly and configured to contribute to creation of a desired effect.

### RELATED APPLICATIONS

This application claims priority to U.S. Provisional Patent Application No. 63/127,944 filed Dec. 18, 2020, the entirety of which is hereby incorporated by reference herein.

### BACKGROUND

### Field

Embodiments disclosed herein relate generally to scooters and related vehicles and toys. In particular, certain embodiments relate to scooter assemblies equipped with one or more assemblies configured to generate electrical energy.

### Background

Many types of scooters exist, including two-wheeled and three-wheeled scooters and electric scooters. A need exists for improved scooters designs or other movable device designs that further enhance the experience for the user.

### SUMMARY

The systems, methods and devices described herein have innovative aspects, no single one of which is indispensable or solely responsible for their desirable attributes. Without limiting the scope of the claims, some of the advantageous features will now be summarized.

According to some embodiments, the various concepts disclosed herein can be applied to one or more moving toys or vehicles, such as, for example, scooters, bicycles, other cycles, skateboards, skates (e.g., roller skates, roller blades, push cycles, other push toys, any item or device having one or more wheels or other movable members or components, etc.), pushtoys and/or the like.

Generally, the various embodiments discussed herein include devices, systems and/or methods for providing electrical power to one or more components of a vehicle or toy. In some embodiments, electrical power is generated by movement of a device (e.g., a toy) without the use of batteries or other power source. In some arrangements, manual movement of such a vehicle, toy or other manually-powered device can help create and supply electrical power to one or more outputs, such as, for example, visual assemblies (e.g., light emitting diodes (LEDs), other types of the light assemblies, smoke or other gas generation, other visual outputs, articulating or movable members, etc.), audible outputs (e.g., speakers or other noise-producing devices, etc.), haptic outputs, and/or the like.

According to some embodiments, a scooter configured to create a desired effect comprises a scooter body configured to support a user, at least one output device configured to contribute to creation of the desired effect, and a control unit configured to selectively operate the at least one output device. In some embodiments, the at least one output device comprises one or more of the following: a visual output, an audible output, an olfactory output, and a tactile or other somatosensory output.

According to some embodiments, a manually-powered movable device comprises at least one wheel configured to move when a user operates the device, an electrical energy generating assembly, wherein the electrical energy generating assembly comprises a magnet assembly and a coil assembly, wherein the magnet assembly is configured to move when the at least one wheel is moved, wherein the coil assembly is configured to remain stationary relative to a frame of the device when the at least one wheel is moved, and wherein relative movement between the magnet assembly and the coil assembly generates electrical energy, at least one wire assembly coupled to the electrical energy generating assembly, and at least one output device coupled to the at least one wire assembly and configured to contribute to creation of a desired effect.

According to some embodiments, the manually-powered movable device comprises a scooter. In some embodiments, the manually-powered movable device comprises a skateboard. In some embodiments, the manually-powered movable device comprises a skate (e.g., roller skate, rollerblade, etc.). In some embodiments, the manually-powered movable device comprises a cycle (e.g., bicycle, tricycle, etc.). In some embodiments, the manually-powered movable device comprises a push toy.

According to some embodiments, the electrical energy generating assembly is configured to generate DC power. In some embodiments, the electrical energy generating assembly is configured to generate AC power. In some embodiments, the AC power comprises three-phase AC power.

According to some embodiments, the electrical energy generating assembly is concentric with the at least one wheel. In some embodiments, the electrical energy generating assembly is not concentric with the at least one wheel.

According to some embodiments, a longitudinal axis of the electrical energy generating assembly is at an angle relative to a longitudinal axis of the at least one wheel (e.g., 5, 10, 15, 30, 45, 60, 75, 80, 85, 95, 0 to 90, 0 to 15, 15 to 30, 0 to 30, 30 to 45, 45 to 60, 30 to 60, 60 to 75, 75 to 90, 60 to 90 degrees, etc.).

According to some embodiments, the electrical energy generating assembly is positioned within the at least one wheel. In some embodiments, the electrical energy generating assembly is not positioned within the at least one wheel.

According to some embodiments, the electrical energy generating assembly is in direct contact with the at least one wheel. In some embodiments, the electrical energy generating assembly is not in direct contact with the at least one wheel.

According to some embodiments, at least one of the electrical energy generating assembly and the at least one wheel comprises a layer, portion and/or other adaptation that is configured to increase friction. In some embodiments, the layer, portion and/or other adaptation comprises a rubber, elastomeric or polymeric material. In some embodiments, the layer, portion and/or other adaptation comprises a non-smooth, roughened or textured surface or portion configured to increase friction.

According to some embodiments, the electrical energy generating assembly is mechanically coupled to the at least one wheel using at least one intermediate member. In some embodiments, the at least one intermediate member comprises a flexible coupling component (e.g., a chain, a belt or another flexible or movable member, etc.). In some embodiments, the at least one intermediate member comprises at least one wheel. In some embodiments, the at least one intermediate member comprises at least one gear. In some embodiments, the at least one intermediate member comprises a belt, a chain or another flexible or movable member or component.

According to some embodiments, the electrical energy generating assembly is mechanically coupled to the at least one wheel using at least one intermediate member. In some embodiments, the at least one intermediate member comprises at least one wheel. In some embodiments, the at least one intermediate member comprises at least one gear.

According to some embodiments, the magnet assembly comprises a ring magnet assembly.

According to some embodiments, the at least one output device comprises a visual output. In some embodiments, the visual output comprises at least one light. In some embodiments, the at least one light comprises at least one light emitting diode (LED). In some embodiments, the visual output comprises at gas-emitting device.

According to some embodiments, the at least one output device comprises a non-visual output. In some embodiments, the at least one output device comprises an audible device. In some embodiments, the at least one output device comprises a movable output device.

According to some embodiments, the at least one output device comprises an electrical storage device. In some embodiments, the electrical storage device comprises at least one of a capacitor and a rechargeable battery. In some embodiments, the at least one output device comprises a port configured to receive a cable. In some embodiments, the cable is configured to at least partially charge an electronic device (e.g., a smartphone, a smart tablet, etc.).

According to some embodiments, the device further comprises at least one processor or controller. In some embodiments, the processor or controller is configured to control at least one aspect of the device. In some embodiments, the processor or controller comprises a button, switch or other controller. In some embodiments, the processor or controller is configured to control at least one aspect of the at least one output device.

According to some embodiments, the device further comprises at least controller, wherein the at least one controller is configured to regulate the delivery of energy from the electrical energy generating assembly to the at least one output device. In some embodiments, the at least one controller controls whether the electrical energy generating assembly is able to generate electrical energy.

According to some embodiments, the at least one controller regulates the amount, if any, electrical energy generated by the electrical energy generating assembly is delivered to the at least one output device.

According to some embodiments, the at least one controller is configured to be included physically on the manually-powered movable device. In some embodiments, the at least one controller is positioned or otherwise configured to permit a user to manipulate said at least one controller with his or her hand while the manually-powered movable device is being ridden. In certain arrangements, the at least one controller comprises a button, a handlebar, a switch or other manually movable component.

According to some embodiments, the at least one controller is not positioned or otherwise configured to permit a user to manipulate said at least one controller with the user's hand while the manually-powered movable device is being ridden. In some embodiments, the at least one controller is positioned within, at least partially, in a smartphone or another device comprising a processor.

### BRIEF DESCRIPTION OF THE DRAWINGS

These and other features, aspects and advantages are described below with reference to the drawings, which are intended to illustrate embodiments of electric vehicles, such as two-wheeled and three-wheeled scooters, as well as embodiments of various components of these electric vehicles.

FIG. 1 schematically illustrates one embodiment of a movable item that incorporates an assembly configured to electrically energize one or more outputs;

FIG. 2 schematically illustrates one embodiment of an assembly configured to electrically energize an output for a movable item;

FIG. 3 illustrates a bottom view of a scooter comprising an assembly configured to electrically energize an output according to one embodiment;

FIG. 4 illustrates a different view of the scooter of FIG. 3;

FIGS. 5 to 7 illustrate different views and/or components of an assembly configured to electrically energize an output according to one embodiment;

FIG. 8 illustrates a portion of one embodiment of an assembly configured to electrically energize an output;

FIG. 9 illustrates the assembly of FIG. 8 positioned within a recess of a wheel;

FIGS. 10 and 11 illustrate a skateboard having a wheel with an assembly configured to electrically energize an output according to one embodiment;

FIG. 12 illustrates a bottom view of a scooter comprising an assembly configured to electrically energize an output according to one embodiment;

FIGS. 13A to 13C illustrate a bottom view of a scooter comprising an assembly configured to electrically energize an output according to one embodiment;

FIGS. 14A and 14B schematically illustrate embodiments of a wheel or other movable component configured to be in direct contact with an assembly configured to electrically energize an output;

FIG. 15 schematically illustrates one embodiment of a movable item that incorporates an assembly configured to electrically energize one or more outputs and/or other devices;

FIG. 16 illustrates a perspective view of one embodiment of a vehicle (e.g., a skateboard) that include at least one output device (e.g., a LED strip or series of LEDs) positioned along a groove or recess formed along a side surface of a vehicle component (e.g., a deck);

FIG. 17A illustrates a close-up perspective view of the deck of the skateboard of FIG. 16;

FIG. 17B illustrates a cross-sectional view taken along the skateboard of FIGS. 16 and 17B; and

FIG. 17C illustrates a close up of the cross-sectional view of FIG. 17B.

### DETAILED DESCRIPTION

Embodiments of systems, components and methods of assembly and manufacture will now be described with reference to the accompanying figures, wherein like numerals refer to like or similar elements throughout. Although several embodiments, examples and illustrations are disclosed below, it will be understood by those of ordinary skill in the art that the disclosure herein extends beyond the specifically disclosed embodiments, examples and illustrations, and can include other uses and obvious modifications and equivalents thereof. The terminology used in the description presented herein is not intended to be interpreted in any limited or restrictive manner simply because it is being used in conjunction with a detailed description of certain specific embodiments. In addition, embodiments described herein can include several novel features and no single feature is solely responsible for its desirable attributes or is essential.

Certain terminology may be used in the following description for the purpose of reference only, and thus are not intended to be limiting. For example, terms such as “above” and “below” refer to directions in the drawings to which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import.

While the description sets forth specific details of various embodiments, it is to be appreciated that the description is illustrative only and should not be construed in any way as limiting. Additionally, although particular embodiments may be disclosed or shown in the context of particular types of manual or electric vehicles, such as manual or motorized three-wheeled scooters, it is understood that any elements of the disclosure may be used in any type of vehicle or toy including, but not limited to, two-wheeled scooters and trolleys.

The various embodiments disclosed herein can be incorporated into any type of scooter or other vehicle design, such as, by way of example, manual (e.g., non-motorized) scooters, trolleys, bicycles, tricycles, other cycles, skateboards, skates, push toys, other movable vehicles or toys, other movable devices and/or the like.

Generally, the various embodiments discussed herein include devices, systems and/or methods for providing electrical power to one or more components of a vehicle or toy. In some arrangements, manual movement of such a vehicle, toy or other manually-powered device can help create and supply electrical power to one or more outputs, such as, for example, visual assemblies (e.g., light emitting diodes (LEDs), other types of the light assemblies, smoke or other gas generation, other visual outputs, articulating or movable members, etc.), audible outputs (e.g., speakers or other noise-producing devices, etc.), haptic outputs, and/or the like.

According to some embodiments disclosed in the present application, an assembly configured to generate electrical energy (e.g., electric motor, magnet motor, etc.) when a user manually moved the vehicle, toy or other device in which the assembly is positioned. As a result of the movement to the vehicle, toy or other device, and thus the assembly that is coupled (e.g., directly or indirectly) to a wheel or other movable member of such a vehicle, toy or other device, the assembly can generate electrical energy. Such energy can be used to electrically activate one or more outputs positioned in, on and/or near the vehicle, toy or other device.

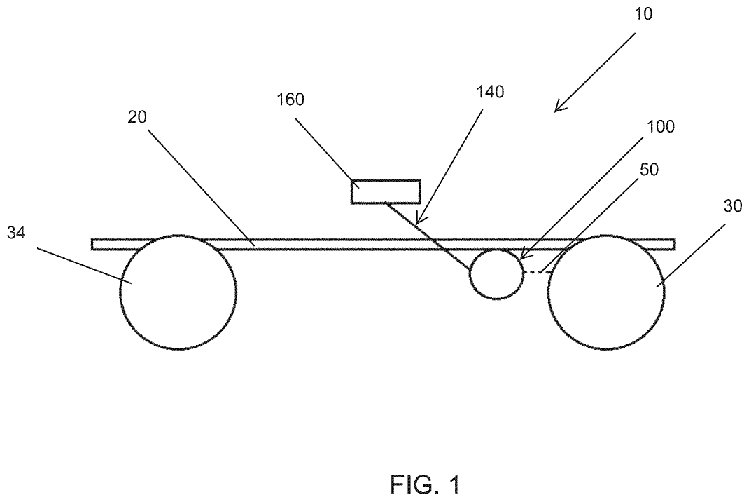

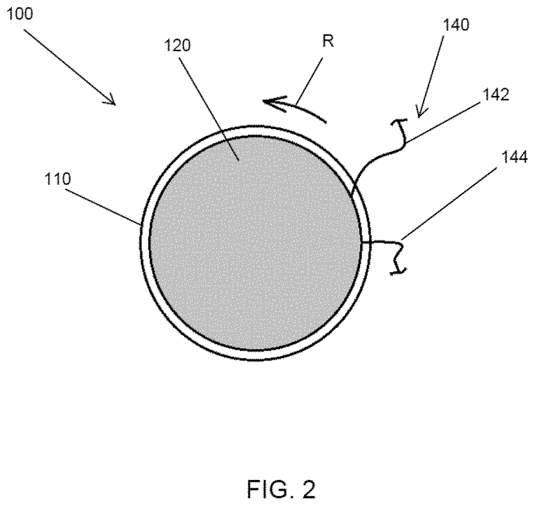

According to some embodiments, as schematically illustrated in FIGS. 1 and 2, the assembly 100 incorporated into a vehicle, toy or other movable device 10 can include a ring magnet assembly 110 and a corresponding coil assembly 120 positioned adjacent to the ring magnet assembly 110. In various embodiments disclosed herein, the ring magnet assembly 110 is configured to be moved relative to a stationary coil assembly (e.g., a series of coils in the coil assembly that rotate relative to the ring magnet). As the ring magnet assembly is moved relative to the corresponding stationary coil assembly (e.g., a plurality of coils), electrical energy can be advantageously generated (e.g., in accordance with electric motor or magnet motor concepts). The relative movement of the ring magnet assembly and the coil assembly can be created by manual movement by a user of a scooter, roller skate, skateboard and/or any other wheel or other movable member.

In some embodiments, as discussed in detail below, energy generated by the assembly 100 can be used to electrically energize one or more outputs and/or other devices or components. Such electrical energy can be generated by moving (e.g., manually moving) one or more wheels or other movable members of a vehicle, toy or other item (e.g., scooter, skateboard, skate, cycle, push toy, etc.).

In some embodiments, only a single wheel of the vehicle or toy includes the ring magnet and coil assembly components (e.g., the necessary components to generate electrical energy). However, in other arrangements, two or more wheels of a vehicle or toy include the ring magnet and coil assembly components, as desired or required by a particular application or use.

The various arrangements disclosed herein can provide one or more benefits to a scooter, skateboard, roller skate and/or other vehicle, push toy, movable toy or other movable device. For example, one or more of the embodiments can help energize one or more outputs (e.g., LEDs, electroluminescent paint, other lights or components configured to generate light, other visual output, audible outputs, tracking devices, analytics devices, sensors, other electrical components, etc.) using the manual movement of a wheel without the use of batteries or another power source. In some embodiments, manual movement of a vehicle, toy or other device (and thus, one or more wheels or other movable members of such a vehicle, toy or other device) can help provide power to a capacitor, rechargeable battery and/or another device capable of storing electrical energy. Stored electrical energy can be configured to power one or more outputs and/or other devices or components (e.g., a charging port for a phone or other electronic device). In some embodiments, a port (e.g., USB, USB-C, etc.) can be provided that is energized, directly or indirectly (e.g., using a battery or other energy storage device and/or other components). Such a port can be used to charge a separate electronic device, such as, for example and without limitation, a smartphone, a smart tablet, another computing device, a GPS transponder or other tracking device, etc.).

With reference to FIG. 1, a scooter (or any other type of vehicle, movable toy or other movable device) 10 can include at least one wheel 30, 34. In some embodiments, depending on the type of device 10, the device can include one, two, three, four or more wheels, as desired or required. For any of the embodiments disclosed herein, the device 10 can include a scooter, a skateboard, a skate (e.g., roller skate), a cycle (e.g., bicycle, tricycle, etc.), a wagon, a push toy and/or any other vehicle, toy or device with at least one wheel or other movable member. As shown in FIG. 1 (and other embodiments herein), the vehicle 10 (e.g., scooter, skateboard, etc.) can include a deck 20 on which users step or otherwise position their feet during use.

As depicted in FIG. 1, the device 10 can include a deck or other portion 20 that is shaped, sized and otherwise configured to support a human (e.g., a shoe, a seat, etc.). Regardless of the exact configuration and design of the device 10, at least one of the wheels or other movable members 30 can be adapted to transfer motion or otherwise move a component of an assembly 100 that is configured to generate electrical power as a result of such movement. In some embodiments, the wheel or other movable member 30 is in direct contact with the portion of the assembly (e.g., the coil) that moves in order to generate electrical energy.

In other embodiments, however, the wheel or other movable member 30 is indirectly coupled to the portion of the assembly (e.g., the coil) that moves in order to generate electrical energy. For example, as shown schematically in FIG. 1, the wheel 30 can be mechanically coupled to the assembly 100 using or more intermediate members 50, such as, e.g., another wheel, a gear, another type of moving member and/or the like, as desired or required.

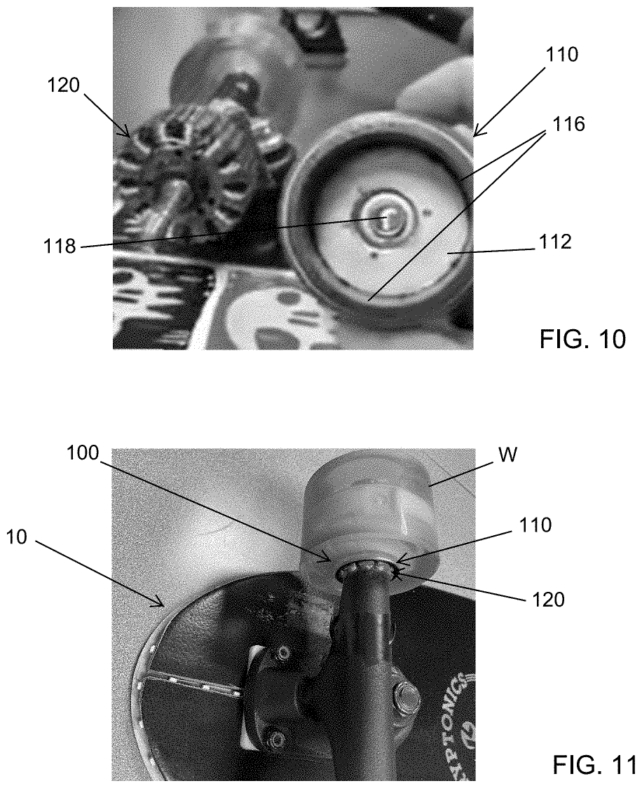

As discussed in greater detail below, the electrical energy generating assembly 100 can include a movable ring magnet assembly and a stationary coil assembly. In some embodiments, the ring magnet assembly can be configured to move (e.g., rotate) relative to the coil assembly when the scooter, skateboard, skate, cycle, push toy and/or any other device when the device is manually moved by a user. In some embodiments, the ring magnet forms a continuous circular (e.g., round) shape and the coil assembly includes two or more separate coils (e.g., as illustrated in FIGS. 7 and 10, for example). The use of a continuous ring magnet and a plurality of coil can help improve the electrical output and/or the efficiency (e.g., overall efficiency) of the assembly 100, as desired or required. For example, in alternative designs where the magnet coverage (e.g., size, magnetic force, etc.) is not continuous or otherwise smaller or less impactful and/or the coil contribution to the electrical energy generation is smaller or less impactful, the ability to generate greater electrical energy (e.g., to power one or more output and/or other electronic components) is diminished.

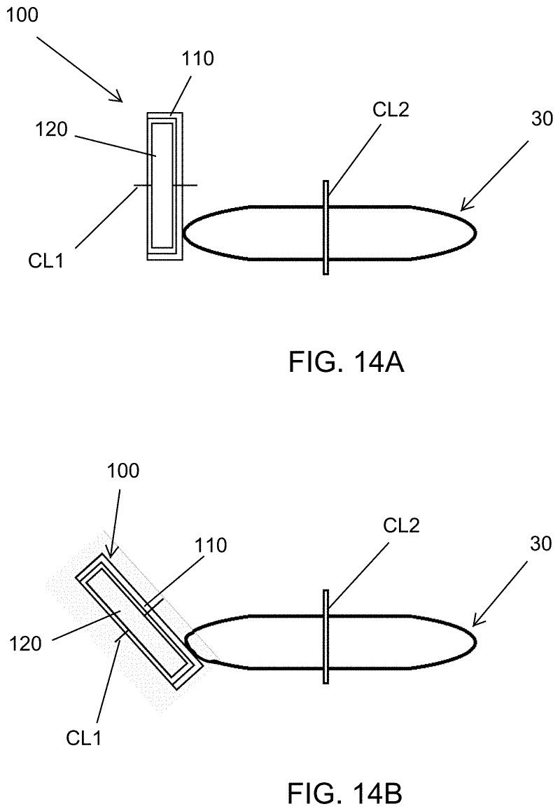

With continued reference to FIG. 1, a set of wires or other electrical conductors 140 can electrically couple the assembly 100 to one or more outputs 160. As discussed herein, an output 160 can comprise a visual, an audible and/or any other output. As discussed with respect to FIG. 14, the wires or other electrical conductors 140 can be configured to electrically couple an assembly to one or more other devices or components, such as, for example, an electrical energy storage device (e.g., capacitor, rechargeable battery, etc.), another electrical component or member (e.g., an electrical charging port, LEDs, electroluminescent paint, other lights or components configured to generate light, other visual output, audible outputs, tracking devices, analytics devices, sensors, other electrical components, etc.) and/or the like, as desired or required.

FIG. 2 schematically illustrates one embodiment of an assembly 100 that is configured to generate electrical energy when a manually-operated device (e.g., scooter, skateboard, skate, push toy, etc.) is moved. As shown, the assembly 100 can include ring magnet assembly 110 and an adjacently-positioned coil assembly 120. In some embodiments, the ring magnet assembly 110 is continuous or substantially continuous along a circumferential perimeter. When a user takes the appropriate action to manually move the corresponding device (e.g., relative to a ground surface), the ring magnet assembly 110 can rotate relative to the coil assembly 120. Such relative movement can create electrical energy that is transmitted away from the assembly 100 using a wire or other electrical conductor assembly 140. In some embodiments, the wires or other electrical conductor assembly 140 comprises two or more (e.g., 2, 3, 4, more than 4, etc.) individual wires that are configured to electrically couple to an output and/or another electrical device or component. For instance, the wire or conductor assembly 140 can include two or three wires 142, 144, as desired or required.

As noted above, movement of the ring magnet assembly 110 relative to the coil assembly 120, electrical energy can be generated by the assembly 100. In some embodiments, the coil assembly 120 is stationary, while the ring magnet assembly 110 is configured to be moved (e.g., directly or indirectly by a wheel or other movable member when a scooter, other vehicle, other toy and/or any other movable device). In such embodiments, the more durable component, i.e., the ring magnet 110, is configured to rotate about one or more coils of a coil assembly 120. As used in this context, movable and stationary are relative terms that refer to movement relative to a deck or other portion of the vehicle or toy.

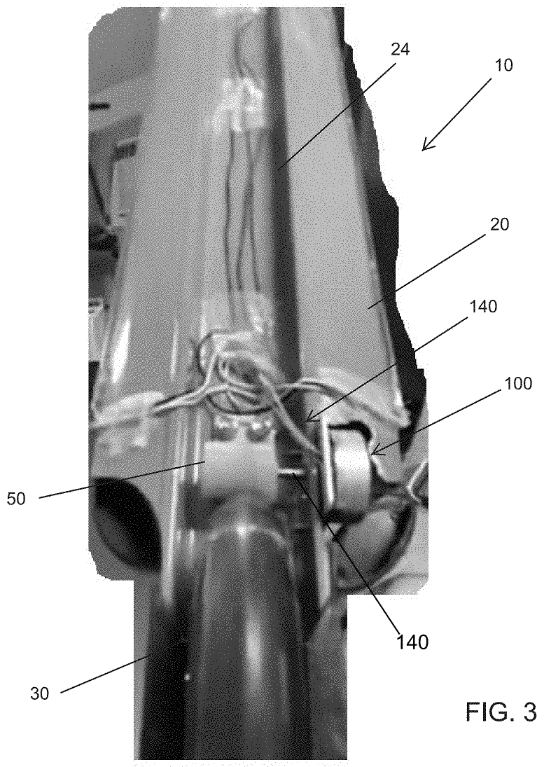

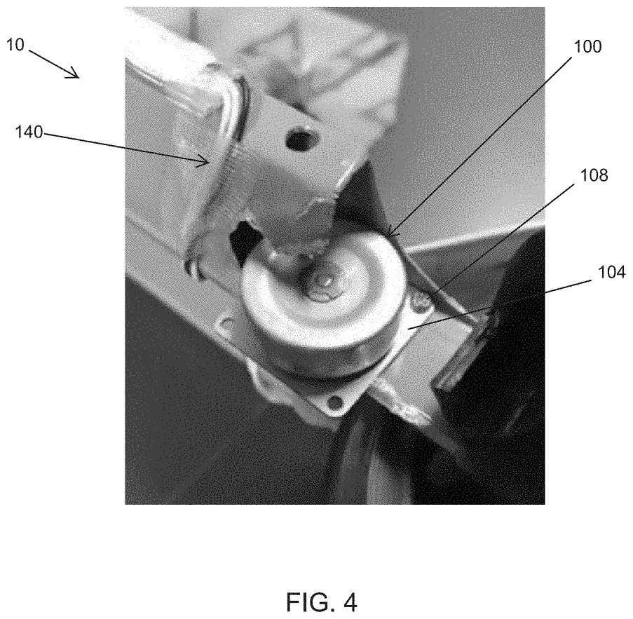

With reference to FIGS. 3 and 4, a scooter 10 can include an assembly 100 configured to generate electrical energy when the scooter is manually moved by a user (e.g., pushed along a ground surface). As shown, in some embodiments, manual movement of the scooter 10 causes the wheels (e.g., the front wheel 30, the rear wheel (not shown), another wheel, etc.) of the scooter to rotate. Rotation of a wheel 30 can move the ring magnet of the assembly 100 that is positioned within and/or along that wheel. In the depicted arrangement, an intermediate member 50 (e.g., a secondary wheel or rotating member) is in contact with the front wheel 30 of the scooter. Movement of the front wheel 30 rotates the intermediate wheel or rotating member 50 that is in physical contact with the front wheel 30.

With continued reference to FIGS. 3 and 4, as the intermediate wheel or member 50 is moved (e.g., by manual movement of the front wheel 30 of the scooter 10), rotational movement by the intermediate wheel or member 50 is transferred to the ring magnet assembly of the assembly 100 via an axle or some other member 140. Thus, in embodiments such as the one illustrated in FIGS. 3 and 4, the assembly configured to generate electrical energy 100 is not concentric (e.g., does not share a common longitudinal axis) with the wheel or other movable member 30 of the scooter or other device 10. However, as discussed below, the assembly configured to generate electrical energy 100 can be concentric (e.g., the assembly shares a common longitudinal axis) with the wheel or other movable member 30 of the scooter or other device 10, as desired or required.

As illustrated in FIG. 3, electrical energy generated by the assembly 100 can be transferred to one or more outputs and/or other components or devices (not shown) via a wire or other electrical conductor assembly 140. In FIG. 3, the wire assembly 140 can include two or more individual wires or electrical conductors that are routed through and/or along one or more areas or portions of the scooter or other device 10. For instance, the wires can be positioned, at least partially within, a recess or other opening 24 along the bottom of the scooter. In other arrangements, the wires can be routed at least partially through an interior (e.g., non-exposed, non-visible, etc.) portion of the scooter or other device 10, as desired or required.

FIG. 4 illustrates a different view of the assembly 100. As shown, the assembly 100 can include a plate or other member 104 that is configured to be secured to one or more portions of the body or other component of the scooter or other device 10. In some embodiments, the assembly 100 is configured to be permanently or removably secured to the scooter or other device 10 (e.g., via welding, adhesives, screws, bolts, other mechanical devices, etc.). In the depicted arrangement, for example, the assembly 100 is secured to the scooter body using one or more screws or bolts.

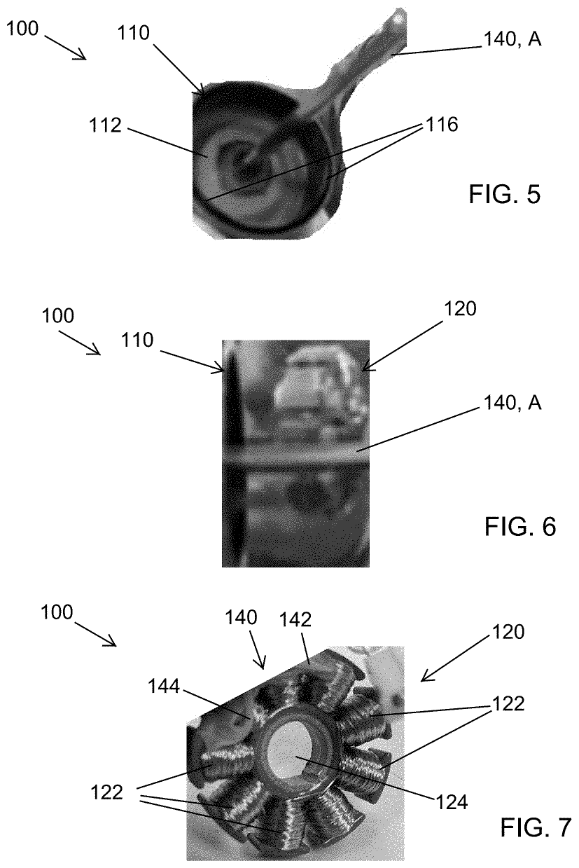

FIGS. 5 to 7 illustrate various components of an assembly 100 configured to generate electrical energy when actuated or otherwise moved (e.g., rotated). As shown in FIG. 5, the assembly 100 can include a ring magnet assembly 110. The ring magnet assembly 110 can include a cylindrical or other circularly-shaped housing 112 and a cylindrical or circular magnet 116 positioned therein. In some embodiments, the magnet 116 is secured to an interior of a cylindrical portion of the housing 112. The magnet 116 can include a singular magnet that completely or partially surrounds the interior of the housing. However, in other embodiments, two or more magnets or magnet portions can be used in an assembly ring magnet assembly 110. In some embodiments, the magnets or magnet portions form a continuous or substantially continuous circular shape, with no or very minor breaks or interruptions (e.g., with 0% to 5% or 0% to 10% or 0 to 25% of the circumference including gaps or breaks in the magnet, less than 5%, less than 10%, less than 20%, less than 25%, less than 30%, less than 40%, less than 50% of the circumference including gaps or breaks in the magnet, values between the foregoing ranges and values, etc.).

In some embodiments, as illustrated in FIGS. 5 and 6, the ring magnet assembly 110 can be coupled to an axle A, 140. Such an axles or other member A, 140 can be configured to couple to another member (e.g., intermediate wheel or member 50, a gear and/or the like) that permits the ring magnet assembly 110 to be moved when the wheel or other movable member 30 of the scooter or other vehicle, toy or device is manually operated by a user.

As noted above, and with reference to FIGS. 6 and 7, the electrical energy generating device or assembly 100 can further include a coil assembly 120 that is configured to be positioned within a recess, gap or other opening formed by the ring magnet assembly 110. As shown, the coil assembly 120 can include a plurality of coil members 122 in accordance with a desired or required assembly design or configuration. In the depicted arrangement, the coil assembly 120 comprises a total of nine coil members that are radially oriented along a center of the coil assembly 120. However, in other embodiments, more or fewer coil members 122 can be included in a coil assembly 120 (e.g., 2, 3, 4, 5, 6, 7, 8, 10, 11, 12, 13, 14, 15, 16, 17, 18, more than 18, etc.).

In some embodiments, the coil assembly 120 comprises two or more (e.g., 2, 3, 4, 5, 6, 7, 8, 9, 10, more than 10, etc.) coil members 122. In some embodiments, the use of two or more coil members 122 can increase the electrical output capacity of the electrical energy generating device or assembly 100 and/or increase its operating efficiency.

With continued reference to FIG. 7, the coil assembly 120 can include a central opening 124 that is sized, shaped and otherwise configured to accommodate an axle or other similar member 140 of the assembly 100. As noted herein, in some embodiments, the coil assembly 120 is configured to be stationary relative to the ring magnet assembly 110 and other components of the scooter or other vehicle, toy or device (e.g., deck, steering tube, handlebar, seat, etc.).

As illustrated in FIG. 7, a wire or other electrical conductor assembly 140 can be coupled (e.g., directly or indirectly) to the coil assembly 120. As discussed above, the wire other electrical conductor assembly 140 can include one, two, three or more individual wires or other electrical conductors 140, 142 that are configured to be electrically coupled to one or more outputs (e.g., LED systems, other lighting systems, other visual outputs, audible outputs, other types of outputs, etc.) and/or another type of electrically-powered device or component (e.g., a capacitor, rechargeable battery or the electrical energy storage device, a charging port, etc.), as desired or required. Such outputs and/or other devices or components can be secured (e.g., permanently or removably) to the scooter or other device 10.

According to some embodiments, the electrical energy generating device or assembly 100 can be configured to generate DC or AC power, as desired or required. In some embodiments, AC power is generated by the assembly 100 in order to improve the function, protect and/or provide one or more other benefits or advantages to the LED lights or other output or component that is electrically coupled to the assembly 100. For example, the use of AC power can help protect LED lights electrically coupled to the assembly 100 by reducing the likelihood of providing power that is above a recommended power level to a light assembly or other electrically-powered output. This can occur because of the ability to modulate LEDs and/or other lights or output between “on” and “off” positions. Therefore, as the assembly 100 is operating (e.g., when a user exerts a force and/or moment to move the corresponding vehicle, toy or other device, and thereby, move a wheel assembly of such a vehicle, toy or other device), an AC power configuration will repeatedly and temporarily (e.g., alternatively) provide power and cease providing power to any LED, other light source and/or other output to which it is electrically coupled.

In other embodiments, as discussed with additional detail herein, the power generated by an assembly 100, irrespective of whether it is DC or AC power, can be “stored” and used at a later point in time using one or more additional electrical components, e.g., a capacitor, a battery, a circuit and/or the like, as desired or required.

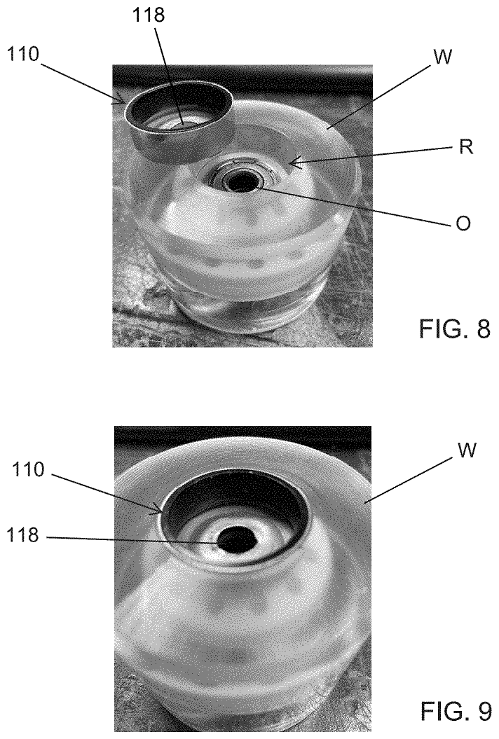

FIGS. 8 and 9 illustrate an electrical energy generating device or assembly 100 that is configured to be positioned within a recess or other opening R of a wheel W. As shown, the recess R can be positioned along the exterior (or interior) region of the wheel W and can be sized, shaped and otherwise configured to receive a ring magnet assembly 110 of the assembly 100. Thus, in such embodiments, the ring magnet assembly, and therefore the entire electrical energy generating device or assembly 100, is configured to be concentric with the wheel that provides it with the necessary manual movement in requires to generate electrical energy.

As noted in other portions of the present application, the use of a ring magnet that extends along all or substantially all of the circumference of the electrical energy generating device or assembly 100 can improve the electrical output and/or electrical efficiency of the assembly 100 (e.g., in comparison to assemblies that are non-continuous or less continuous). As also noted herein, the use of a plurality (e.g., 2, 3, 4, 5, 6, more than 6) individual coils in a coil assembly can further improve the output, efficiency and/or other operating parameters of the assembly 100.

For example, possible assemblies that utilize a plurality of magnets (e.g., non-continuous, substantially non-continuous magnets, etc.) in an assembly create less electrical output and/or are less electrically efficient than embodiments disclosed herein. Further, in some embodiments, using a moving coil assembly (e.g., relative to a deck or other portion of a vehicle, toy or other device in which an assembly is incorporated) can provide certain disadvantages. For example, coil assemblies, by their nature, are delicate and easy to damage, especially when compared to a more durable ring magnet or other solid magnet member that is sized, shaped and otherwise configured to rotate relative to the coil assembly to generate electrical energy.

In some embodiments, using a solid ring assembly that is positioned along the inner diameter or portion of a wheel (e.g., for a skateboard, scooter, roller skate, etc.) can allow for a small separation distance between the ring magnet and the adjacent coil assembly. For example, in some arrangements, the magnet itself is positioned along the interior-most portion of the wheel, and as such, helps form, at least in part, the interior surface of the wheel assembly. In embodiments where magnets (e.g., individual magnets) are mounted within the wheel, for many reasons (e.g., including protection of the magnets, especially when there are multiple magnets that do not form a circular shape) the magnets are located away from the interior surface of the wheel. As used herein, interior surface refers to the interior surface of the wheel that is configured to be positioned immediately along the axle or other member onto which the wheel is mounted. In some embodiments, the minimum distance between the ring magnet material and the adjacent coil member of the coil assembly is less than 5 mm, less than 4 mm, less than 3 mm, less than 2 mm, less than 1 mm, less than ½ mm, values between the foregoing, etc.). However, in other embodiments, the minimum distance between the ring magnet material and the adjacent coil member of the coil assembly is between 5 mm and 10 mm (e.g., 5, 6, 7, 8, 9, 10 mm, values between the foregoing, etc.), between 10 mm and 15 mm, between 15 mm and 20 mm, values between the foregoing, etc.).

In some embodiments, once the ring magnet assembly 110 has been secured within the recess R of the wheel W, the ring magnet assembly 110 is flush or substantially flush relative to the exterior surface of the wheel W. However, in other embodiments, the ring magnet assembly 110 can be configured to be positioned deeper within the recess R of the wheel W or can extend beyond the exterior surface of (e.g., proud relative to) the wheel W, as desired or required. For example, in some embodiments, the exterior of the ring magnet assembly 110 is 0 mm to 0.5 mm, 0.5 mm to 1 mm, 1 mm to 2 mm, 2 mm to 3 mm, 3 mm to 4 mm, 4 mm to 5 mm, 0 mm to 5 mm, 1 mm to 5 mm, 2 mm to 5 mm proud or recessed relative to an exterior of the rest of the wheel, as desired or required.

Further, as illustrated in FIGS. 8 and 9, the ring magnet assembly 110 can include a central opening O that is aligned with the opening of the wheel W. Such an opening O can provide a passageway for an axle (not shown) to secure to the coil assembly (also not shown). The opening O can also provide a passageway for a wire assembly (not shown) of the coil assembly to be routed away from the assembly 100.

In some embodiments, the ring magnet assembly 110 illustrated in FIGS. 8 and 9 can be positioned in a wheel of a skateboard, roller skate, other type of skate, scooter, other vehicle or toy, a push toy and/or any other device. As noted, such a configuration creates an in-line or concentric orientation between the electrical energy generating device or assembly 100 and the wheel W. However, as discussed with reference to other embodiments herein, the assembly 100 can be non-concentric relative to the wheel that is helping move the ring magnet assembly 110.

With continued reference to FIGS. 8 and 9, the ring magnet assembly 110 of the assembly 100 can be secured within the recess R of the wheel W using any one of a variety of devices, methods or technologies. For example, the magnet assembly 110 can be press fit or friction fit into the recess R. In other embodiments, the magnet assembly 110 can be secured within the recess, and thus the wheel W, using adhesives, screws, bolts, tabs and/or other fasteners and/or any other device or method, as desired or required.

FIGS. 10 and 11 illustrate yet another embodiment of an electrical energy generating assembly 100 being concentrically positioned within a wheel W of a device 10. In the depicted arrangement, the ring magnet assembly 110 is positioned along an interior portion of a wheel (e.g., relative to the axle of the wheel). As shown, the coil assembly 120 of the electrical energy generating assembly 100 can be secured to the truck of the skateboard 10. In some embodiments, as discussed herein, the coil assembly 120 can be stationary relative to the truck and/or portions of the skateboard. Although this embodiment is illustrated in the context of a skateboard 10, it will be understood that the wheel W with the electrical energy generating assembly 100 can be incorporated into any other type of vehicle, toy or other movable item, such as, for example, a skate, a scooter, a cycle, a push toy and/or the like.

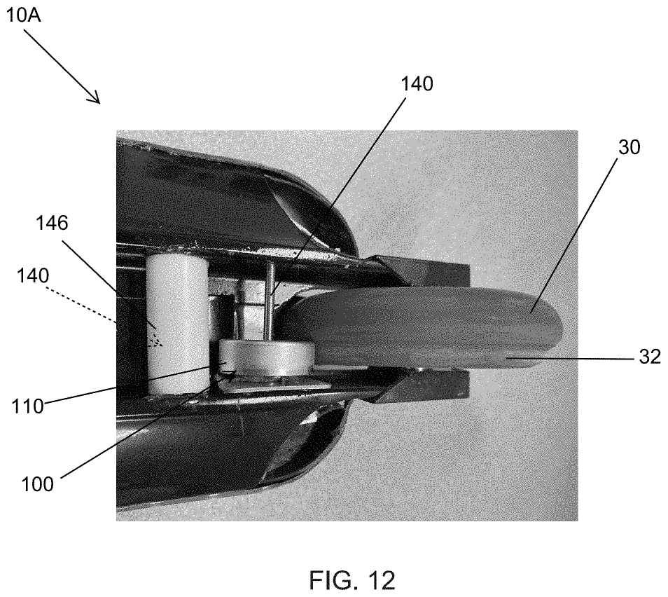

FIG. 12 illustrates yet another embodiment of a scooter 10A that comprises an electrical energy generating assembly 100. As shown, the assembly 100 can be positioned, sized, shaped and otherwise configured to contact at least a portion 32 of a wheel 30 of the scooter 10A. In some embodiments, the portion 32 of the wheel 30 that contacts and transfers mechanical movement to the assembly 100 can be offset relative to the centerline of the wheel 30, as depicted in FIG. 12. However, in other embodiments, the assembly 100 can be in-line or aligned with the wheel 30, as desired or required.

With continued reference to FIG. 12, the electrical energy generating assembly 100 comprises a ring magnet assembly 110 (e.g., in accordance with other embodiments disclosed herein) that is configured to contact the wheel 30 and be moved as the wheel is moved (e.g., as a result of manual movement of the scooter 10A). A coil assembly (not shown) can be positioned within an interior of the ring magnet assembly 110 of the assembly 100. In some arrangements, such a coil assembly can be stationary (e.g., relative to the frame of the scooter or other device 10A and can be coupled to an electrical wire assembly 140 that supplies electrical power to one or more outputs and/or other electrical components.

As illustrated in FIG. 12, the assembly 100 can be mounted on an axle 140 that extends across a portion of the bottom of the scooter 10A. The axle 140 can help ensure that the electrical energy generating assembly 100 can be reliably maintained in the illustrated position during use (e.g., capable of withstanding the forces, moments, stresses and/or other potentially undermining events in might encounter during use).

With continued reference to FIG. 12, a tube or other protective member 146 can be used to shield (e.g., partially or completely) any portion of the wire assembly 140 and/any other electrical or other member located along the bottom of the scooter or other device 10A, as desired or required.

In FIG. 12, as noted above, the ring magnet assembly 110 of the assembly 100 is positioned such that it contacts a side portion 32 of the wheel 30 of the scooter. As shown, such a side portion 32 is specifically shaped, sized and configured to contact the ring magnet assembly 110. In some arrangements, the portion 32 is located along the end of the wheel 30. The side portion 32 can be manufactured (or modified after manufacture) to include the desired shape to permit enhanced contact with the wheel.

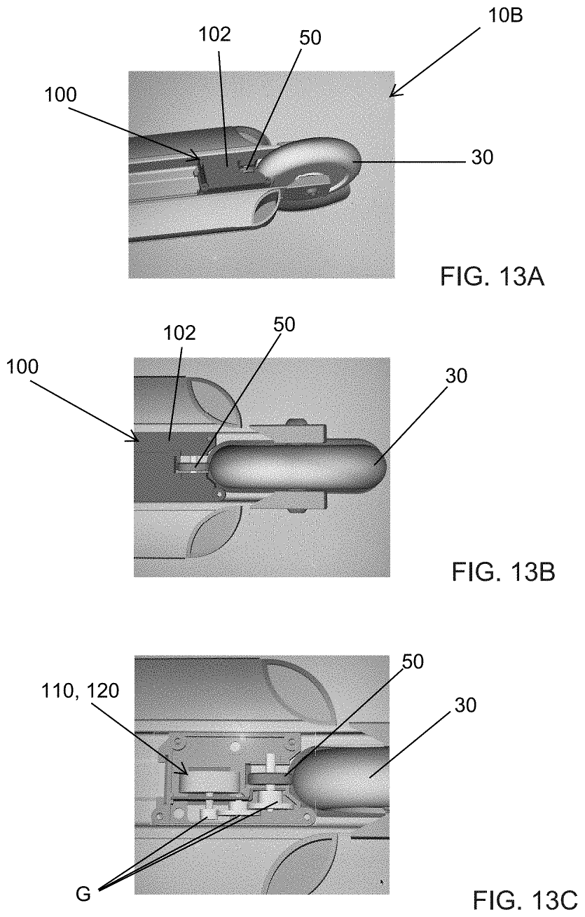

FIGS. 13A to 13C illustrate an embodiment of an electrical energy generating assembly 100 that is included as part of a larger (e.g. drop-in) component for the scooter 10B. As shown, the assembly 100 is configured to be positioned adjacent a wheel of a scooter or other device 10B. The assembly 100 can be positioned along and secured to the bottom of the scooter or other device 10B.

With continued reference to FIGS. 13A to 13C, the assembly 100 comprises a wheel or other intermediate or movable member 50 that is configured to be in contact with the wheel 30 of the scooter or other device 10B. Thus, as the wheel of the device 10B is moved (e.g., manually by the user), the intermediate or movable member 50 is also moved. As shown in FIG. 13C, the assembly 100 can include one or more gears or other mechanical energy transfer devices G that help transfer the movement of the intermediate or movable member 50 to the ring magnet assembly 110.

In FIGS. 13A to 13C, the assembly 100 is configured in a manner that at least partially shields and protects the ring magnet assembly 110 and the coil assembly 120 from the environment. For example, the assembly 100 can include a bottom cover 102 that is configured to cover at least some or all of the interior components of the assembly 100, including the ring magnet assembly 110 and the coil assembly 120. In some embodiments, the assembly 100 can be sized, shaped and otherwise configured to be positioned within a recess or other opening along the bottom of the scooter 10B. The assembly 100 can be secured to the scooter using one or more connection devices, methods or other technologies, such as, for example, screws, bolts, other mechanical fasteners, friction fit or press fit connection, adhesives, welds and/or the like.

As discussed with reference to other embodiments herein, an electrical energy generating assembly 100 can be in direct contact with a wheel or other movable member of a scooter, roller skate, skateboard, push toy and/or other movable device. In such arrangements, movement of a wheel or other movable member can directly cause (e.g., via directly contacting or mechanical coupling) the movable portion of the assembly (e.g., the ring magnet assembly) to move (e.g., rotate) relative to the corresponding portion of the assembly (e.g., the coil assembly). In other embodiments, however, the electrical energy generating assembly 100 is not in direct contact with a wheel or other movable member, as desired or required.

As illustrated in FIGS. 8 to 12, in some embodiments there is direct contact between a wheel or other movable member 30 of a device (e.g., scooter, roller skate, skateboard, cycle, push toy, etc.). Therefore, when the wheel or other movable member of a device is rotated (e.g., via manual energy provided by the user), rotational energy is transferred from the wheel or other movable member to the movable portion (e.g., the ring magnet assembly) of the electrical energy generating assembly 100.

In the embodiments depicted in FIGS. 8 to 12, the axial or rotational axis or centerline of the wheel or other movable member 30, W is parallel or substantially parallel relative to the axial or rotational axis or centerline of the assembly 100. However, in other arrangements, the axial or rotational axis or centerline of the wheel or other movable member 30, W is not parallel or substantially parallel relative to the axial or rotational axis or centerline of the assembly 100. For example, as illustrated schematically in FIG. 14A, the axial or rotational axis or centerline of the wheel or other movable member 30, W is perpendicular (e.g., at a right angle or 90 degrees) relative to the axial or rotational axis or centerline of the assembly 100. Accordingly, as the wheel or other movable member 30, W is moved, rotational energy from the wheel or other movable member 30, W is transferred to the movable component (e.g., the ring magnet assembly 110) of the electrical energy generating assembly 100.

In other embodiments, as schematically illustrated in FIG. 14B, the axial or rotational axis or centerline of the wheel or other movable member 30, W is at an angle relative to the axial or rotational axis or centerline of the assembly 100. In some configurations, the angle can be between 0 and 90 degrees (e.g., 15, 30, 45, 60, 75, 0 to 15, 15 to 30, 0 to 30, 30 to 45, 45 to 60, 30 to 60, 60 to 75, 75 to 90, 60 to 90 degrees, values between the foregoing, etc.), as desired or required. In some configurations, the angle is greater than 0 and less than 90 degrees (e.g., 15, 30, 45, 60, 75, 0 to 15, 15 to 30, 0 to 30, 30 to 45, 45 to 60, 30 to 60, 60 to 75, 75 to 90, 60 to 90 degrees, values between the foregoing, etc.), as desired or required.

In embodiments where there is direct contact between the wheel or other movable member 30, W and the movable portion of the assembly 100, one or more components and/or layers or coatings can be provided along one or more of the surfaces that are configured to contact one another. For example, in some arrangements, one or both of the wheel (or other movable member) 30, W and the movable portion or component (e.g., the ring magnet assembly 110) of the assembly 100 can include, among other things, a rubber or other elastomeric and/or thermoplastic layer, component, area and/or portion that increases friction and helps improve the transfer of rotational energy (e.g., movement) from the wheel or other movable member to the assembly 100. Such a layer, can improve the efficiency of mechanical energy (e.g., rotational) transfer between the wheel or other movable member being manually propelled or otherwise powered by the user's actions and the assembly 100. In some embodiments, such a layer or other component of the wheel (or other movable member) 30, W and/or the assembly 100 can include rubber, urethane and/or the like, as desired or required.

In other embodiments, as discussed herein (e.g., with reference to FIGS. 3, 4 and 13A to 13C), there is no direct contact between the wheel or other movable member of a device and the assembly 100 that helps generate electrical energy when the device is manually operated. In such embodiments, as discussed herein, one or more intermediate members, devices and/or components can be used to transfer the mechanical (e.g., rotational) energy from the wheel or other movable member of the device being manually operated by a user and the movable portion or component (e.g., ring magnet assembly 110) of an assembly 100.

According to some embodiments, an intermediate member can include, without limitation, one or more of the following: a wheel, a gear or gear system, a belt, a chain, another type of flexible movable component or member configured to transfer mechanical energy, etc.

For any of the embodiments disclosed herein, one or more electrical energy regulating or limiting devices or components can be used to ensure that the DC or AC energy that is generated by an assembly does not place the one or more outputs of an arrangement in danger and/or does not electrically overstress such outputs, as desired or required. For example, in some embodiments, a device or system can include a component or device that reduces or otherwise limits (e.g., at or below a particular threshold) the voltage and/or amperage provided to one or more outputs.

In several of the embodiments disclosed herein, the energy generating device comprises a ring magnet assembly that is configured to rotate or otherwise move relative to a stationary coil assembly when the scooter, cycle, skateboard, roller skate, push toy and/or other device is manually moved. However, for any of the arrangements disclosed herein, the assembly can be modified such that the coil assembly is moved while the adjacent ring magnet assembly is stationary. In such embodiments, any necessary changes to wiring and/or the like can be incorporated, as desired or required.

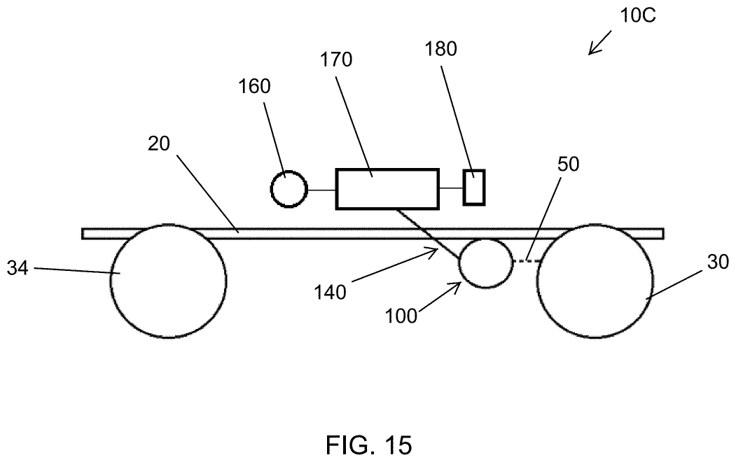

FIG. 15 schematically illustrates yet another embodiment of a scooter or other movable device 10C that is configured to receive an electrical energy generating assembly 100. The illustrated arrangement is similar to the one shown in FIG. 1 and discussed herein. However, the embodiment of FIG. 15 contemplates the wire or other electrical conductor assembly 140 coupling the assembly 100 to electrical devices or components outside of the output context. In some embodiments, the assembly 100 can be used to deliver electrical power that is generated by the assembly (e.g., as a result of a user manually moving the device).

With continued reference to the schematic of FIG. 15, the scooter or other movable device 10C can include one or more capacitors, rechargeable batteries and/or other electrical power storage device or component 170. Such a device or component 170 can be designed and otherwise configured to selectively provide electrical power to one or more outputs and/or other devices or components configured to use electrical power 160 (e.g., as described herein with respect to other arrangements). Such outputs and/or other devices or components can include, without limitation, LED lights, other lights, other visual output, audible outputs, haptic or other movable outputs, electronic device charging ports or devices and/or the like.

In some embodiments, the electrical power storage device or component 170 is configured to store electrical energy generated by the assembly 100 while a user is using (e.g., riding) the scooter or other manually-powered device 10C. Therefore, in some such embodiments, the device/system can include one or more additional electrical components, as desired or required (e.g., capacitors, conductors, resistors, ports, diodes, circuit boards, etc.).

In some embodiments, an output can be customized and/or replaced/switched by a manufacturer and/or user. For example, a standard or non-standard electrical coupling (not shown) can be connected to the electrical energy generating assembly 100. Such a coupling can be configured to electrically couple the assembly 100 to any one of a variety of electric or electronic components, devices or systems, including without limitation, LEDs or other lights, audible output devices, device that generate visible, non-light focused output (e.g., smoke or other gas emitting devices) and/or the like. In some embodiments, outputs can include GPS or other location devices, other sensors, hubs or other devices or components used for analytics and/or the like.

In some embodiments, the vehicle or toy (e.g., scooter, skateboard, etc.) can include, at least partially along its surface, electroluminescent paint and/or similar coatings or layers that are configured to be electrically energized. Such paint or other members can benefit of having one or more electrical energy generating assembly 100 positioned on the corresponding vehicle, toy or other member to help supply electrical power to it. As with any other output, electroluminescent paint can be advantageously electrically activated as the user is moving the vehicle, toy or other device without the need for batteries, another similar power source and/or the like.

In some embodiments, the electrical power storage device or component 170 is configured to power an USB port, Micro-USB port, Micro-B connector and/or any other port (e.g., standard or non-standard) that is configured to receive a cord or cable. Such a port can be used to power one or more other devices, such as, for example, a smartphone, a tablet and/or the like.

According to some embodiments, the scooter or other movable device 10C can further include one or more processors and/or controllers 180 that are configured to selectively control one or more outputs and/or other devices or components coupled to the electrical power storage device 170. Thus, a user can selectively control the operation of the outputs and/or other devices or components 160. For example, a user can turn on or off and/or control the operation of LED lights or other outputs positioned on the scooter or other device.

In some embodiments, the processors and/or controllers 180 can include a switch, button, touchscreen, another input or output device and/or any other processor. For example, in some embodiments, the processor or controller comprises a controller that is configured to communicate with and be controlled by a smartphone application or other computing device. In some embodiments, the processor or controller 180 comprises a switch or button that is positioned along an area of the scooter or other device 10C (e.g., handles, handlebar assembly, etc.) that the user can manipulate while riding or otherwise using the device 10C.

In some embodiments, the output 160 of a scooter, skateboard, skate, push toy, cycle and/or other device includes LEDs or other lights positioned along one or more portions of the device (e.g., deck, wheels, neck portion, frame, fork, steering tube, seat, handles, handlebar and/or the like). In other embodiments, as noted herein the output can include a gas generating output, another visual output, an audible output (e.g., sounds (e.g., screeching sounds denoting acceleration or deceleration, music, etc.), a motion activating output and/or the like, as desired or required.

For any of the embodiments disclosed herein, the scooter or other movable device can include at least one controller that is configured to control and/or otherwise regulate the selective generation and/or transfer of electrical energy related to electrical energy produced by an electrical energy generating assembly. Such a controller can be positioned to prevent or otherwise inhibit or limit any interaction within and/or related to the electrical energy generating assembly itself. For example, such a controller or other device or component can prevent relative movement of energy generating portions of the assembly itself. In some embodiments, some decoupling mechanical or technology can be incorporated into a desired design.

In other embodiments, such a device or component can limit or prevent the transfer of any electrical energy generated by the assembly to any downstream output. For instance, in some embodiments, such a device or component can include a switch or other electronic/electrical device or component that regulates the flow of electrical current from the assembly to one or more outputs to which the assembly is electrically coupled.

In some embodiments, such a controller comprises a handle, a cable (e.g., mechanical, electrical, etc.) and/or other manipulatable controller and/or other electronic/electrical component or device. For example, in some arrangements, such a controller includes a handle or other device or component (e.g., switch, button, etc.) that can be selectively controlled by a user to activate and/or deactivate one or more of the outputs to which the assembly is electrically coupled.

In some embodiments, a smartphone and/or computing device can be configured to operatively coupled to the controller and/or one or more components of the device (e.g., assembly, electrical conductor or wiring, processors, etc.) to further enhance the control the delivery of energy from the energy generating assembly to one or more outputs.

For any of the embodiments disclosed herein, the electrical energy generating assembly used in a vehicle, toy or other device is configured to generate 3-phase AC power. In some embodiments, as discussed herein, the uses of AC power (e.g., as compared to DC power) can provide one or more benefits or advantages. For example, the use of 3-phase power can help ensure that the power delivered to an output (e.g., LEDs, other light source, etc.) will not be excessive. For example, in some instances, using DC power can create a situation where an excessive amount of electrical energy is delivered to an output. In some arrangements, such a situation, which could be caused by a wheel or other member in which a power generation assembly is positioned is going above a threshold rotational speed, can damage an output. The use of 3-phase AC power, given its intermittent delivery of electrical energy, can inherently avoid such issues and/or provide additional advantages or benefits (e.g., without the use of additional electrical components, such as, for instance, capacitors, resistors, diodes, etc.).

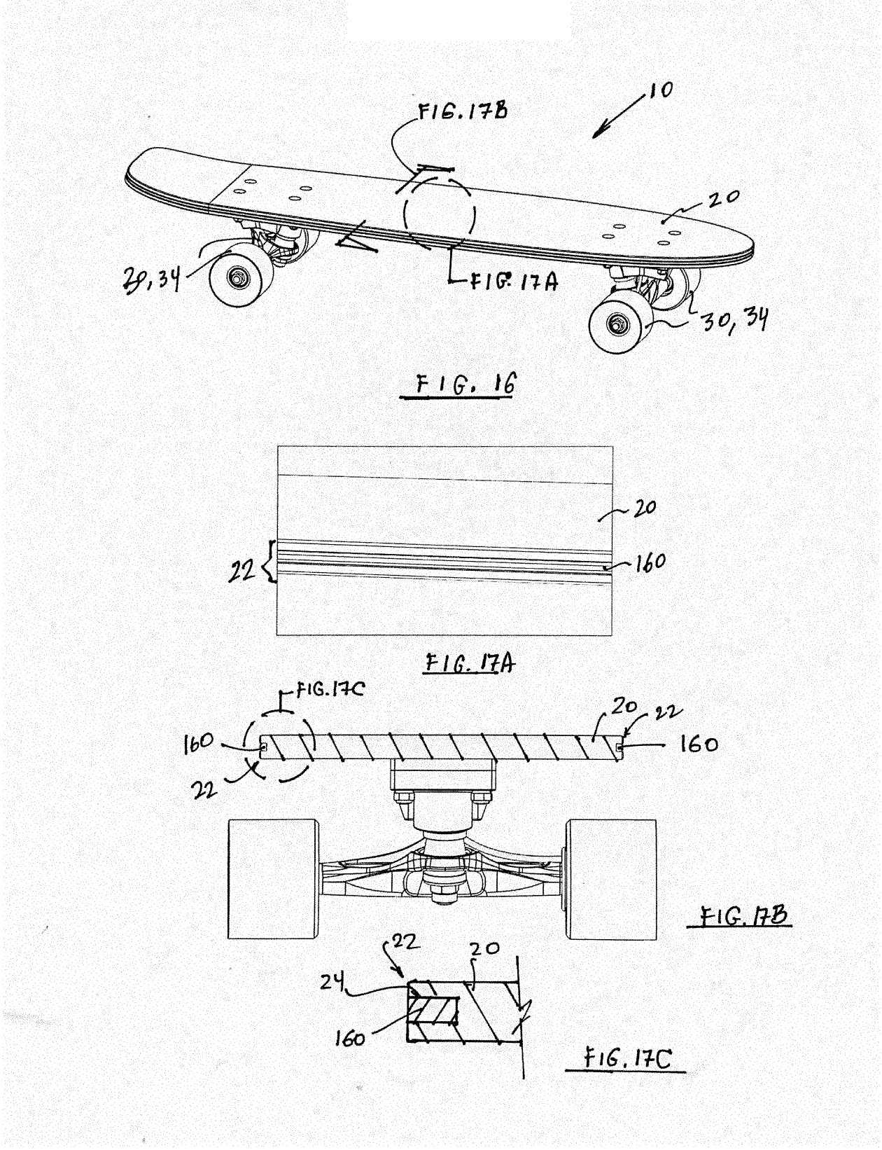

A skateboard or other vehicle 10 equipped with one or more electrical energy generating assemblies (e.g., in one or more of its wheels) can include one or more outputs 160 along one or more of its surfaces and/or portions. As illustrated in FIG. 16, the output 160 can include a plurality of LEDs or other light sources. Therefore, as the user moves the skateboard (or other vehicle, toy or device) 10 along a surface and one or more of the wheels equipped with an electrical energy generating assembly are rotated, electrical energy (e.g., 3-phase AC power) is generated by the assembly or assemblies. Such power can be provided via wires and/or additional electrical components to LEDs and/or other outputs 160 located along one or more regions, portions or areas of the skateboard (or other vehicle, toy or device), as desired or required.

In some embodiments, as depicted in FIG. 16, the skateboard or other device 10 includes a deck 20 (or other rigid or support structure) in or within which, at least partially, LEDs, other lights and/or other output(s) are secured. For example, as illustrated in FIGS. 17A to 17C, one or more outputs (e.g., LED strip, other LED configuration, other output, etc.) 160 are positioned within a groove or other recess 24 of the deck 20. As shown, the groove or recess 24 is formed along a side surface 22 of the deck 20. In some embodiments, the groove or recess 24 is continuous along the entire extent of the exterior portion along which the groove or recess 24 is located (e.g., along the side surface 22, top surface, bottom surface, etc.). However, in other embodiments, the groove or recess 24 is located only along a portion of the exterior surface. Thus, the groove or recess 24 can be intermittent or discontinuous (non-continuous), as desired or required.

As illustrated in FIGS. 17B and 17C, the width of the groove GW (e.g., the distance to which the groove or recess 24 extends relative to the outside surface (e.g., of the outside surface 22) of the deck or other component 20 of the vehicle, toy or other device 10 is based or depends, at least in part, on the dimension of the output 160 and its related components (e.g., strips, electrical conductors, hubs, etc.). In some embodiments, when the output 160 (including all or most of its components) are positioned within the groove or recess 24, the output 160 and all (or at least most) of its related components are sized, shaped and otherwise configured to fit completely within the groove or recess 24 (e.g., such that no portion of the output and/or its related component extend beyond the groove or recess 24 toward an exterior of the deck or other corresponding component of the vehicle, toy or device).

Such configurations can provide one or more advantages or benefits to the vehicle, toy or other device 10. For instance, by maintaining the output (e.g., LED strip, other LEDs, other light sources, other output, etc.) within the recess and not extending past the exterior surface of the corresponding groove or recess 24, the output can be protected such that it maintains its functionality and ability to operate if the vehicle, toy or other device encounters a potentially-damaging event (e.g., a collision, another type of accident or fall, another impact event, etc.). For example, as opposed to other technologies that may or may not exist, the present embodiments do not include outputs that are likely to be damaged while the corresponding vehicle, toy or other device is being used.

As noted above, the groove or recess 24 within a deck 20 (or other component or portion of a vehicle, toy or device) can be continuous or intermittent from a starting location to an ending location. In some embodiments, the starting and ending locations are identical (e.g., the groove or recess 24 is created along a loop). However, in other embodiments, a groove or recess 24 is positioned along only a portion of a device, as desired or required.

In some embodiments, the groove or recess 24 is formed when the deck 20 or other component that will at least partially receive an output is manufactured. However, in alternative embodiments, the groove or recess 24 is formed after manufacture using, for example, one or more tools, techniques and/or technologies (e.g., using a router, other groove making device or system, casting, etc.).

By embedding, at least partially, an output device within a groove or recess of a component of a vehicle, toy or device, the output device is protected from possible damage that may occur during use.

While certain embodiments have been described, these embodiments have been presented by way of example only, and are not intended to limit the scope of the disclosure. Indeed, the novel systems and methods described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope of the disclosure. Accordingly, the scope of the present disclosure is defined only by reference to the claims presented herein or as presented in the future.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, or 0.1 degree.

1. A manually-powered movable device comprising:
at least one wheel configured to move when a user operates the device;
an electrical energy generating assembly;
wherein the electrical energy generating assembly comprises a magnet assembly and a coil assembly;
wherein the magnet assembly is configured to move when the at least one wheel is moved;
wherein the coil assembly is configured to remain stationary relative to a frame of the device when the at least one wheel is moved; and
wherein relative movement between the magnet assembly and the coil assembly generates electrical energy;
at least one wire assembly coupled to the electrical energy generating assembly; and
at least one output device coupled to the at least one wire assembly and configured to contribute to creation of a desired effect.

2. The device of claim 1, wherein the manually-powered movable device comprises a scooter.

3. The device of claim 1, wherein the manually-powered movable device comprises a skateboard.

4. The device of claim 1, wherein the manually-powered movable device comprises a skate.

5. The device of claim 1, wherein the manually-powered movable device comprises a cycle.

6. The device of claim 1, wherein the manually-powered movable device comprises a push toy.

7. The device of claim 1, wherein the electrical energy generating assembly is configured to generate DC power.

8. The device of claim 1, wherein the electrical energy generating assembly is configured to generate AC power.

9. The device of claim 8, wherein the AC power comprises three-phase AC power.

10. The device of claim 1, wherein the electrical energy generating assembly is concentric with the at least one wheel.

11. The device of claim 1, wherein the electrical energy generating assembly is not concentric with the at least one wheel.

12. The device of claim 11, wherein a longitudinal axis of the electrical energy generating assembly is at an angle relative to a longitudinal axis of the at least one wheel.

13. The device of claim 12, wherein the angle is 90 degrees.

14. The device of claim 12, wherein the angle is between 0 and 90 degrees.

15. The device of claim 1, wherein the electrical energy generating assembly is positioned within the at least one wheel.

16. The device of claim 1, wherein the electrical energy generating assembly is not positioned within the at least one wheel.

17. The device of claim 1, wherein the electrical energy generating assembly is in direct contact with the at least one wheel.

18. The device of claim 1, wherein the electrical energy generating assembly is not in direct contact with the at least one wheel.

19. The device of claim 18, wherein at least one of the electrical energy generating assembly and the at least one wheel comprises a layer, portion and/or other adaptation that is configured to increase friction.

20. The device of claim 19, wherein the layer, portion and/or other adaptation comprises a rubber, elastomeric or polymeric material.

21-52. (canceled)
